(19) United States
(12) Patent Application Publication
(10) Pub. No.: US 2024/0175886 A1
(43) Pub. Date: May 30, 2024

(54) ANALYSIS SYSTEM

(71) Applicant: SHIMADZU CORPORATION, Kyoto-shi (JP)

(72) Inventor: Motomu HINOOKA, Kyoto-shi (JP)

(21) Appl. No.: 18/370,275

(22) Filed: Sep. 19, 2023

(30) Foreign Application Priority Data
Nov. 24, 2022 (JP) 2022-187057

(51) Int. Cl. G01N 35/00; G01N 35/02; G01N 35/10

(52) U.S. Cl. CPC G01N 35/0099; G01N 35/026; G01N 35/1011

(57) ABSTRACT

The analysis system is provided with a placement member and an arm mechanism. The placement member has a positioning portion for defining a position of a sample container on a placement surface. The arm mechanism moves the sample container placed on the placement member to the positioning portion to thereby place the sample container at a reference position on the placement member.

### CROSS-REFERENCE TO RELATED APPLICATIONS

This application claims priority under 35 U.S.C. § 119 to Japanese Patent Application No. 2022-187057 filed on Nov. 24, 2022, the entire disclosure of which is incorporated herein by reference in its entirety.

### BACKGROUND OF THE INVENTION

### Field of the Invention

The present disclosure relates to an analysis system.

### Description of the Related Art

The following description sets forth the inventor's knowledge of the related art and problems therein and should not be construed as an admission of knowledge in the prior art.

Conventionally, an analysis system equipped with a pretreatment apparatus is known. The pretreatment apparatus performs a pretreatment on cells contained in a sample, such as, e.g., a culture medium. The pretreatment includes various processing, such as, e.g., centrifugation, liquid removal, reagent supply, agitation, and extraction. The analysis system is equipped with an arm mechanism for moving a sample container containing a sample. The arm mechanism moves the sample container to a location appropriate for the application. After completion of the pretreatment, the pretreated sample is supplied to an analysis device, such as, e.g., a liquid chromatograph mass spectrometer, included in an analysis system.

In Japanese Unexamined Patent Application Publication No. 2019-174369, a pretreatment apparatus equipped with a robot arm is disclosed. The robot arm conveys the sample container gripped by the hand to the pretreatment apparatus.

The analysis system including the pretreatment apparatus is provided with a module for placing the sample container to be pretreated. In order for the pretreatment apparatus to accurately approach the sample in the sample container, the sample container must be placed at a reference position of the module. For this reason, for example, it is conceivable that a positioning vertical wall and a spring mechanism for pressing the sample container against the positioning upright wall by a biasing force are provided on the placement surface of the module. The arm mechanism lowers the sample container, which has been conveyed above the placement surface, toward the placement surface, causing the sample container to be interposed between the vertical wall and the spring mechanism. At this time, the sample container is pressed against the vertical wall by the biasing force of the spring mechanism, and the sample container is fixed at the reference position defined by the vertical wall and the spring mechanism.

In a system using such a spring mechanism, the spring mechanism moves the sample container to the vertical wall. However, in such a system, the arm mechanism requires a force for the sample container to be interposed between the vertical wall and the spring mechanism against the biasing force of the spring mechanism. For this reason, in a system using a spring mechanism, for example, in the process of interposing a sample container between the vertical wall and the spring mechanism, there is a risk that the arm mechanism may have an excessive burden due to the force from the direction of the placement surface.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

The purpose of the present disclosure is to provide an analysis system capable of placing a sample container at a reference position without applying an excessive burden on an arm mechanism.

The analysis system of the present disclosure is an analysis system equipped with a pretreatment apparatus for executing a pretreatment of a sample contained in a sample container, and is provided with a placement member having a placement surface for placing the sample container thereon and an arm mechanism configured to move the sample container. The placement member has a positioning portion for positioning the sample container on the placement surface, and the arm mechanism is configured to move the sample container placed on the placement surface to the positioning portion to place the sample container at a reference position on the placement surface.

The above and other objects, features, aspects and advantages of the present invention will become apparent from the following detailed description of this invention understood in connection with the accompanying drawings.

### BRIEF DESCRIPTION OF THE DRAWINGS

The preferred embodiments of the present invention are shown by way of example, and not limitation, in the accompanying figures.

FIG. 1 is a front view showing a schematic configuration of an analysis system.

FIG. 2 is a see-through perspective view showing a schematic configuration of a pretreatment apparatus.

FIG. 3 is a perspective view showing a configuration of a module.

FIG. 4 is a perspective view showing a module in which a sample container is placed at a reference position.

FIG. 5 is a perspective view showing a configuration of a gripper and the vicinity thereof.

FIG. 6 is a perspective view showing an internal structure of a gripper and the vicinity thereof in an arm.

FIG. 7 is a block diagram showing a configuration of an analysis system.

FIG. 8 is a diagram showing a state in which a gripper is gripping a sample container.

FIG. 9 shows a state in which a sample container gripped by a gripper is placed from above a module on a module board.

FIG. 10 is a diagram showing a state in which a sample container is moved by a gripper in a positive direction of an X-axis.

FIG. 11 is a diagram showing a state in which a sample container is moved by a gripper in a positive direction of a Y-axis.

FIG. 12 is a flowchart showing a procedure for moving a sample container to a reference position.

### DETAILED DESCRIPTION OF THE PREFERRED EMBODIMENTS

In the following paragraphs, some preferred embodiments of the present invention will be described by way of example and not limitation. It should be understood based on this disclosure that various other modifications can be made by those in the art based on these illustrated embodiments.

Hereinafter, some embodiments of the present disclosure will be described with reference to the attached drawings. Note that the same or equivalent part in the figures is assigned by the same reference symbol, and the description thereof will not be repeated.

### <Schematic Configuration of Analysis System 100>

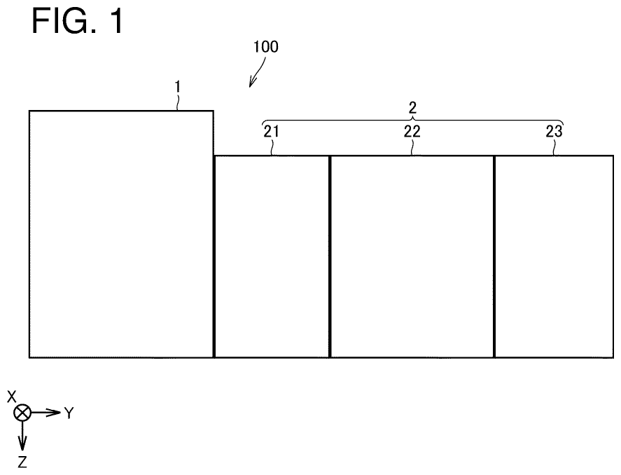

FIG. 1 is a front view showing a schematic configuration of an analysis system 100. In this embodiment, three axes, i.e., an X-axis, a Y-axis, and a Z-axis, which are mutually orthogonal to each other, are defined as shown in the figures. The X-Y plane formed by the X-axis and the Y-axis is a plane parallel to the installation plane of the analysis system 100.

The analysis system 100 is a system for automatically performing a pretreatment and an analysis on an analysis target object. In this embodiment, the analysis target object is a cell contained in a liquid sample, such as, e.g., a culture medium, and more specifically is a fungus.

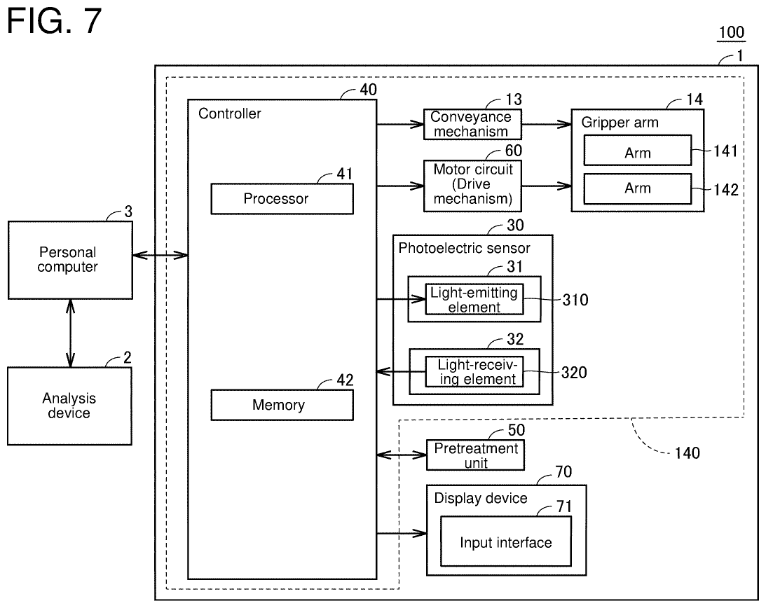

The analysis system 100 includes a pretreatment apparatus 1 and an analysis device 2. The analysis system 100 further includes a personal computer 3 (see FIG. 7). The personal computer 3 is communicatively connected to the pretreatment apparatus 1 and the analysis device 2.

The pretreatment apparatus 1 is equipped with various pretreatment mechanisms, such as, e.g., a centrifugation mechanism, a liquid removal mechanism, a reagent supply mechanism, an agitation mechanism, and an extraction mechanism. The pretreatment apparatus 1 operates those mechanisms to perform a pretreatment on a liquid sample. The pretreatment apparatus 1 may have a function for automatically conveying a liquid sample for which a pretreatment has been completed to an auto-sampler 21.

The analysis device 2 includes the auto-sampler 21, a liquid chromatographic apparatus 22, and a mass spectrometer 23. The auto-sampler 21, the liquid chromatographic apparatus 22, and the mass spectrometer 23 are connected by piping and wiring not shown in the figure. The auto-sampler 21 is a device for sampling a liquid sample from a sample container (labware). The liquid sample on which a pretreatment has been performed by the pretreatment apparatus 1 (hereinafter also referred to simply as “sample”) is introduced into the liquid chromatographic apparatus 22 via the auto-sampler 21. Thereafter, the sample is analyzed by the liquid chromatographic apparatus 22 and the mass spectrometer 23.

In FIG. 1, the auto-sampler 21 is included in the concept of the analysis device 2, but the auto-sampler 21 may be excluded from the concept of the analysis device 2. The liquid chromatographic apparatus 22 and the mass spectrometer 23 are each just one example of an analysis device for analyzing an analysis target object. Other analysis systems may be adopted for the analysis system 100.

### <Schematic Configuration of Pretreatment Apparatus 1>

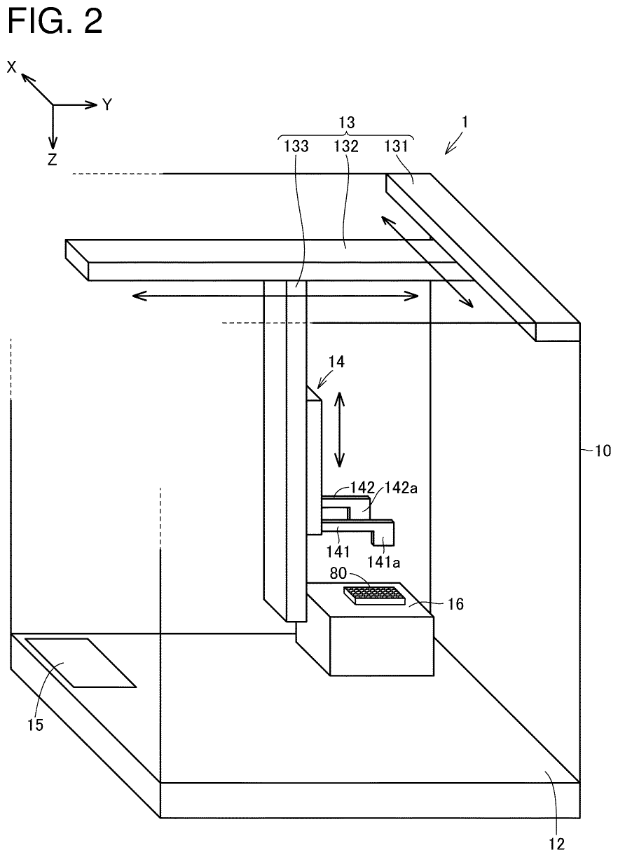

FIG. 2 is a see-through perspective view showing the schematic configuration of the pretreatment apparatus 1. As shown in FIG. 2, the pretreatment apparatus 1 has a table 12 having a top surface parallel to the X-Y plane. The entire space above the table 12 is enclosed by a housing 10. A plurality of modules 16 is mounted on the table 12. In FIG. 2, one of the plurality of modules 16 is shown as a representative example thereof.

On the module 16, a sample container 80 containing a sample to be pretreated is placed. In the module 16, a pretreatment is performed on the sample in the sample container 80.

Above the table 12, a conveyance mechanism 13 is provided. The conveyance mechanism 13 includes an X-axis guide rail 131 extending in the X-axis direction, a Y-axis guide rail 132 extending in the Y-axis direction, and a Z-axis guide rail 133 extending in the Z-axis direction. The X-axis guide rail 131 is attached to the upper portion of the housing 10. The Y-axis guide rail 132 is attached to the X-axis guide rail 131 so that it can move along the X-axis guide rail 131 in the X-axis direction. The Z-axis guide rail 133 is attached to the Y-axis guide rail 132 so that it can move along the Y-axis guide rail 132 in the Y-axis direction. The gripper arm 14 is attached to the Z-axis guide rail 133 so as to be movable in the Z-axis direction.

The conveyance mechanism 13 further includes a plurality of drive mechanisms (not shown). The plurality of drive mechanisms is configured to move the Y-axis guide rail 132 in the X-axis direction, the Z-axis guide rail 133 in the Y-axis direction, and the gripper arm 14 in the Z-axis direction. This causes the gripper arm 14 to move in the three axes directions, i.e., the X-axis direction, the Y-axis direction, and the Z-axis direction, within the housing 10.

The gripper arm 14 has arms 141 and 142. The arm 141 includes a gripper 141a, and the arm 142 includes a gripper 142a. The gripper arm 14 grips the sample container 80 containing a sample with a pair of grippers 141a and 142a and conveys the sample container 80 to the module 16.

On the table 12, a retraction area 15 is provided. The gripper arm 14 moves the sample container 80 to the retraction area 15 as needed.

### <Configuration of Module 16>

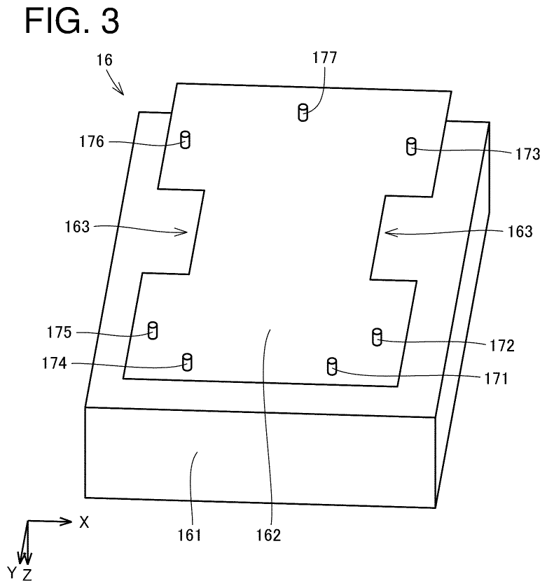

FIG. 3 is a perspective view showing the configuration of the module 16. The module 16 is provided with a module body 161 and a module board 162. The surface of the module board 162 constitutes a placement surface for placing the sample container 80 thereon. A cut-out portion 163 is formed on both sides of the module board 162, the both sides being extended along the Y-axis direction. The module board 162 is arranged above the module body 161 with a support 165 (see FIG. 9) or other means. When the module 16 is viewed from a direction perpendicular to the Z-axis, a space is formed between the module body 161 and the module board 162. When the grippers 141a and 142a are lowered from above the module 16 to the module board 162, the portions of the grippers 141a and 142a are arranged in the cut-out portions 163 and 163.

The surface of the module board 162 is provided with a plurality of pins 171-177. The straight line passing through the pin 171 and the pin 174 is parallel to the X-axis. The straight line passing through the pin 172 and the pin 173 and the straight line passing through the pin 175 and the pin 176 are parallel to the Y-axis. The pins 171-173 and the pins 174-176 are arranged at positions that are line symmetrical with respect to the straight line passing through the pin 177, the straight line being parallel to the Y-axis.

The size of the region formed by connecting the plurality of pins 171-177 is larger than the size of the bottom surface of the sample container 80. The gripper arm 14 conveys the sample container 80 within the region formed by connecting the plurality of pins 171-177.

The reference position for placing the sample container 80 is defined on the module board 162. In this embodiment, the reference position is defined by, for example, the pins 171-173.

The gripper arm 14 conveys the sample container 80 within the region formed by connecting the plurality of pins 171-177. Thereafter, the gripper arm 14 moves the sample container 80 on the module board 162 using the grippers 141a and 142a so that the sample container 80 comes into contact with the pins 171-173. More specifically, the gripper arm 14 moves the sample container 80 in the positive direction of the X-axis and then moves the sample container 80 in the positive direction of the Y-axis.

By moving the sample container 80 in the positive direction of the X-axis, the sample container 80 comes into contact with the pins 172 and 173. By moving the sample container 80 in the positive direction of the Y-axis, the sample container 80 comes into contact with the pin 171. With this, the sample container 80 is placed at the reference position. As described above, in this embodiment, the sample container 80 is placed at the reference position by the grippers 141a and 142a. According to this embodiment, the grippers 141a and 142a, which perform the gripping function of the gripper arm 14, can be effectively utilized for the positioning control.

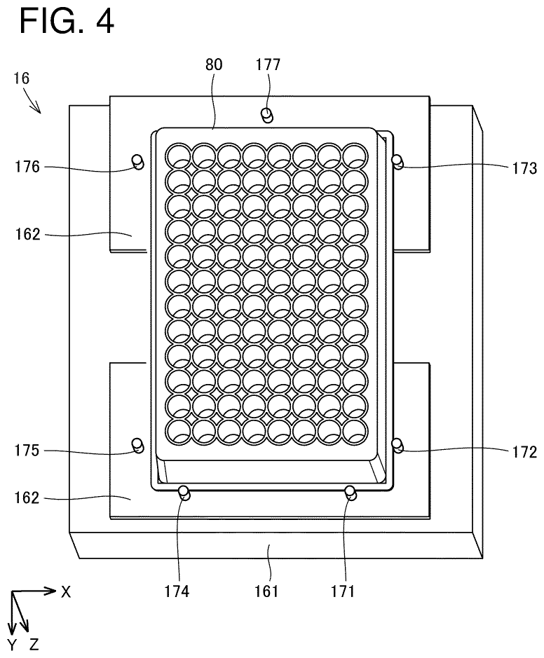

FIG. 4 is a perspective view showing the module 16 in which the sample container 80 is placed at the reference position. As shown in FIG. 4, the module 16 is in contact with the pins 171-173 at the reference position. The bottom surface of the sample container 80 is rectangular, and therefore, when coming into contact with the pins 171-173, the sample container 80 comes into contact with the pin 174 as well. A gap is formed between the pins 175-177 and the sample container 80.

When the pins 171-173 function as positioning pins, the pins 175-177 prevent the sample container 80 from popping out of the module 16 when the module 16 vibrates due to the effects of external disturbances, such as, e.g., earthquakes. In this embodiment, in cases where the pins 171-173 are used to function as positioning pins, the pins 175-177 are not the essential components.

In this embodiment, the pins 171-173 are exemplified as examples of positioning portions. However, in this embodiment, in place of the pins 171-173, a vertical wall provided on the module board 162 may be used to configure the positioning portion. For example, the positioning portion may be constituted by a standing wall that rises along the polygonal line connecting the position of the pin 171, the position where the lower right corner of the sample container 80 shown in FIG. 4 is located, and the position of the pin 172. Alternatively, the positioning portion may be constituted by a first vertical wall that rises along the line segment passing through the location of the pin 171 and parallel to the X-axis, and a second vertical wall that rises along the line segment passing through the position of the pin 172 and parallel to the Y-axis.

However, in order to arrange the sample container 80 at the reference position more precisely, it is preferable to adopt a positioning portion that comes into contact with the sample container 80 at a “point” like a pin, rather than a positioning portion that comes into contact with the sample container 80 at a “plane” like a vertical wall.

### <Configuration of Gripper Arm 14>

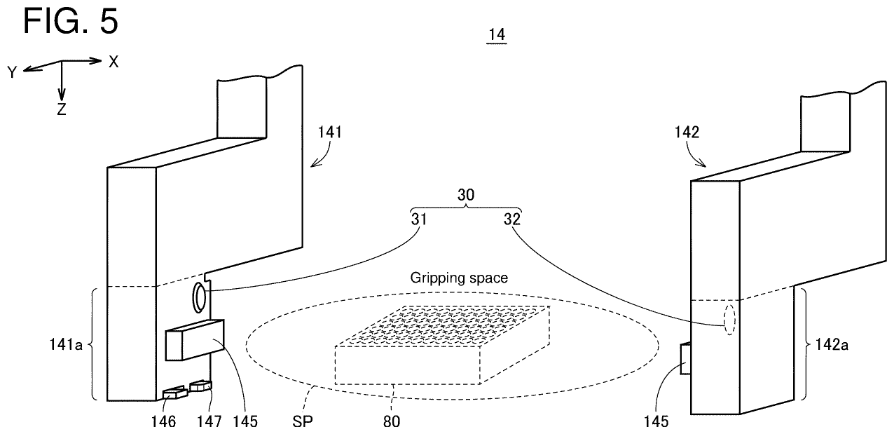

FIG. 5 is a perspective view showing the configuration of the gripper 141a and 142a and the vicinity thereof. The gripper 141a is configured by the portion of the arm 141 that extends in the positive direction (downward direction) of the Z-axis at the tip of the arm 141. The gripper 142a is configured by the portion of the arm 142 that extends in the positive direction (downward direction) of the Z-axis at the tip of the arm 141. Each of the grippers 141a and 142a has a photoelectric sensor 30, a contact portion 145, and protrusions 146 and 147.

Note that the photoelectric sensor 30 and the protrusions 146 and 147 provided on the gripper 142a are located at positions where they are concealed by the gripper 142a in FIG. 5. In FIG. 5, the photoelectric sensor 30 (light-receiving unit 32) provided on the gripper 142a is shown with a dashed line. In FIG. 5, the contact portion 145 and the protrusions 146 and 147 provided on the gripper 142a are not shown.

The contact portion 145 has an approximately rectangular parallelepiped shape and is made of an elastic material, such as, e.g., rubber and sponge. A gripping space SP for the gripper arm 14 to grip the sample container 80 is formed between the gripper 141a and the gripper 142a. The gripper arm 14 changes the size of the gripping space SP by changing the separation distance between the arm 141 and the arm 142 to grip the sample container 80 between the pair of grippers 141a and 142a. At this time, the pair of contact portions 145 each having an approximately rectangular parallelepiped shape comes into contact with the sample container 80.

When moving the sample container 80 in the X-axis direction on the placement surface of the module board 162, the gripper arm 14 moves the gripper 141a in the X-axis direction by bringing the contact portion 145 of the gripper 141a into contact with the sample container 80. Since the contact portion 145 is made of an elastic member, the impact of the sample container 80 when coming into contact with the pins 172 and 173 is absorbed by the contact portion 145. Thus, in this embodiment, the contact portion 145 is used when gripping the sample container 80 and when moving the sample container 80 to the reference position.

The photoelectric sensor 30 is used to detect whether the sample container 80 is present in the gripping space SP. The gripper 141a is provided with a light-projecting unit 31 as the photoelectric sensor 30. The gripper 142a is provided with a light-receiving unit 32 as the photoelectric sensor 30. The light-projecting unit 31 and the light-receiving unit 32 are attached to opposing positions so that the light output from the light-projecting unit 31 passes through the gripping space SP and enters the light-receiving unit 32.

The protrusion 146, 147 is provided on each of the grippers 141a and 142a so as to protrude toward the gripping space SP. When the sample container 80 is being conveyed by the gripper arm 14, unexpected vibrations or other factors may cause the sample container 80 to be detached from the pair of contact portions 145 and 145. The protrusions 146 and 147 hold the sample container 80 between the gripper 141a and the gripper 142a when the sample container 80 is dropped from the contact portion 145 of the gripper 141a and the contact portion of the gripper 142a during the conveyance.

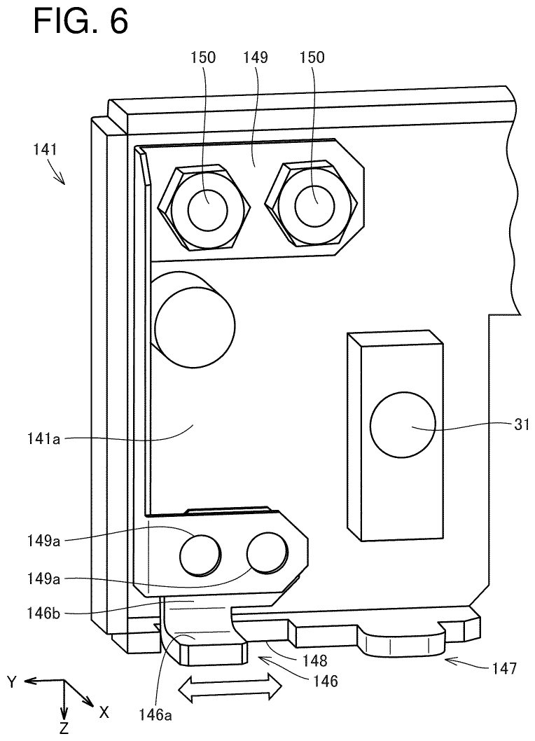

FIG. 6 is a perspective view showing the internal structure of the gripper 141a of the arm 141 and the vicinity thereof. Inside the arm 141, the light-projecting unit 31 and the leaf spring 149 are provided. The light-projecting portion of the light-projecting unit 31 is exposed to the outside of the gripper 141a (see FIG. 5). At the end of the arm 141 (gripper 141a) in the Z-axis direction, a recess 148 and a protrusion 147 are formed. The protrusion 146 is arranged in the recess 148. The protrusion 146 has a body portion 146a and a mounting portion 146b for mounting the protrusion 146 to the arm 141 via the leaf springs 149.

The internal structure of the gripper 141a and the vicinity thereof in the arm 141 and the internal structure of the gripper 142a and the vicinity thereof in the arm 142 are identical, except for the type of the photoelectric sensor 30 attached thereto (the light-projecting unit 31 and the light-receiving unit 32). Therefore, hereinafter, the internal structure of the former will be described, and the description of the former will be substituted for the description of the internal structure of the latter.

One end of the leaf spring 149 is fixed to the arm 141 by bolts 150 and 150. At the other end of the leaf spring 149, holes 149a for fitting parts of the mounting portion 146b are formed. By fitting the mounting portions 146b into the holes 149a, the protrusion 146 is attached to the arm 141 via the leaf spring 149.

The protrusion 146 is attached to the arm 141 (gripper 141a) via the leaf spring 149. For this reason, when a load is applied to the protrusion 146 in the negative direction of the Y-axis, the protrusion 146 moves in the negative direction of the Y-axis while exerting the biasing force corresponding to the magnitude of the load.

When moving the sample container 80 in the positive direction of the Y-axis on the placement surface of the module board 162, the gripper arm 14 moves the grippers 141a and 142a in the positive direction of the Y-axis by bringing the contact portion 146 of the gripper 141a, 142a into contact with the sample container 80. The protrusion 146 is attached to the gripper 141a, 142a via the leaf spring 149. Therefore, the impact of the sample container 80 when it comes into contact with the pins 171 and 174 is absorbed by the protrusion 146. As described above, in this embodiment, the protrusion 146 has a function of preventing the sample container 80 from falling and a function as a buffer when the sample container 80 is moved to the reference position.

If the protrusion 146 were provided on the gripper 141a, 142a without using the leaf spring 149 as in the protrusion 147, the impact generated when the sample container 80 comes into contact with the pins 171 and 174 becomes greater. In this case, the sample container 80 may be damaged. To prevent damage to the sample container 80, it may be necessary to stop the movement of the sample container 80 before it comes into contact with the pins 171 and 174. In this case, the sample container 80 cannot be placed at the reference position. Further, in order to avoid excessive pressing of the sample container 80 against the pins 171 and 174 and ensure the contact of the sample container 80 to the pins 171 and 174, very strict positional control is required. Therefore, in this embodiment, a function as a buffer is added to the protrusion 146.

Instead of connecting the protrusion 146 to the gripper 141a, 142a via the leaf spring 149, the protrusion 146 itself may be made an elastic material, such as, e.g., rubber and sponge. However, it is preferable to use the leaf spring 149 rather than a rubber member or a sponge member. The leaf spring 149 can exert a more responsive biasing force than a rubber member or a sponge member. Therefore, by using the leaf spring 149, the reaction force received from the pins 171 and 174 when the sample container 80 comes into contact with the pins 171 and 174 can be detected promptly. It also prevents a stepping motor of the gripper arm 14 from experiencing a step-out when moving the sample container 80.

Note that in this embodiment, the leaf spring 149 is exemplified as one example of a more optimal elastic member when connecting the protrusion 146 to the gripper 141a, 142a via an elastic member. However, instead of the leaf spring 149, a magnetic spring that uses a magnetic force of a magnet as a restoring force may be adopted. In this embodiment, as examples of more optimal elastic members, the leaf spring 149 and the magnetic spring are exemplified. However, this embodiment does not preclude the protrusion 146 from being made of an elastic member, such as, e.g., rubber and sponge. In other words, in this embodiment, the protrusion 146 may be constituted by an elastic member, such as, e.g., a rubber member and a sponge member. Further, in this embodiment, the protrusion 146 may be configured by the same structure as the protrusion 147.

### <Block Diagram of Pretreatment Apparatus 1>

FIG. 7 is a block diagram showing the configuration of the analysis system 100. As shown in FIG. 7, the pretreatment apparatus 1 is provided with a controller 40, a photoelectric sensor 30, a pretreatment unit 50, a conveyance mechanism 13, a gripper arm 14, a motor circuit 60, and a display device 70. Of these components, the controller 40, the photoelectric sensor 30, the conveyance mechanism 13, the gripper arm 14, and the motor circuit 60 constitute the arm mechanism 140.

The controller 40 includes a processor 41 and a memory 42. The controller 40 is communicatively connected to the analysis device 2 via, for example, a personal computer 3.

The processor 41 is typically a CPU (Central Processing Unit), an MPU (Multi-Processing Unit), or the like. The processor 41 reads out and executes the programs stored in the memory 42 to realize various processing of the pretreatment apparatus 1. The memory 42 is configured to include, for example, a RAM (Random Access Memory), a ROM (Read Only Memory), a flash memory, and a hard disk. The memory 42 stores, in addition to programs executed by the processor 41, various data, such as, e.g., pretreatment setting, and position information (X-coordinate, Y-coordinate, Z-coordinate) of the module 16.

The photoelectric sensor 30 is provided with a light-projecting unit 31 that includes a light-emitting element 310 and a light-receiving unit 32 that includes a light-receiving element 320. The photoelectric sensor 30 emits light to the gripping space SP between the pair of grippers 141a and 142a and detects the light passing through the gripping space SP. The photoelectric sensor 30 is one example of a photoelectric sensor that emits light to the gripping space SP between the pair of grippers 141a and 142a and detects the light from the gripping space SP.

The controller 40 drives the light-projecting unit 31 with a pulse-width modulating signal of, for example, a predetermined pulse width. This causes the light-projecting unit 31 to output light in synchronization with the pulse-width modulation signal. The light-receiving unit 32 detects the light output from the light-projecting unit 31. Upon receipt of light, the light-receiving unit 32 transmits a detection signal to the controller 40. The controller 40 identifies the presence of the sample container 80 between the grippers 141a and 142a, based on the detection of the light by the light-receiving unit 32.

The pretreatment unit 50 executes a pretreatment based on a preset schedule.

The conveyance mechanism 13 includes the X-axis guide rail 131, the Y-axis guide rail 132, and the Z-axis guide rail 133. The conveyance mechanism 13 further includes a plurality of drive mechanisms (not shown). The controller 40 controls the plurality of drive mechanisms to move the Y-axis guide rail 132 in the X-axis direction, the Z-axis guide rail 133 in the Y-axis direction, and the gripper arm 14 in the Z-axis direction along the Z-axis guide rail 133. This causes the gripper arm 14 to move in three axes directions, i.e., the X-axis direction, the Y-axis direction, and the Z-axis direction, within the housing 10.

The motor circuit 60 is one example of a drive mechanism that drives the arms 141 and 142 of the gripper arm 14. As a motor, for example, a stepping motor is used. The controller 40 controls the position of each of the arms 141 and 142 by controlling the motor circuit 60. With this, the position of the gripper 141a formed at the tip of the arm 141 and the position of the gripper 142a formed at the tip of the arm 142 change variously. For example, the controller 40 changes the separation distance between the gripper 141a and the gripper 142a by controlling the motor circuit 60. The controller 40 changes the positional relation between the grippers 141a and 142a and the sample container 80 placed on the module board 162 by controlling the motor circuit 60.

The controller 40 changes the positions of the grippers 141a and 142a by controlling the motor circuit 60 to thereby move the sample container 80 placed on the module board 162 to a reference position. The controller 40 determines the magnitude of the load on the stepping motor included in the motor circuit 60 when the gripper 141a is moving the sample container 80 in the positive direction of the X-axis and when the grippers 141a and 142a are moving the sample container 80 in the positive direction of the Y-axis.

The controller 40 determines that the sample container 80 has contacted the pins 172 and 173 when the magnitude of the load on the stepping motor reaches a threshold when moving the sample container 80 in the positive direction of the X-axis with the gripper 141a. The controller 40 stops the movement of the sample container 80 when the sample container 80 comes into contact with the pins 172 and 173. The controller 40 determines that the sample container 80 has contacted the pin 171 when the magnitude of the load on the stepping motor reaches the threshold when the sample container 80 is being moved by the grippers 141a and 142a in the positive direction of the Y-axis. The controller 40 stops the movement of the sample container 80 when the sample container 80 comes into contact with the pin 171.

The display device 70 includes, for example, a touch panel having an LCD screen. The display device 70 includes an input interface 71 configured by a touch panel. The input interface 71 accepts a touch operation by the user. The input interface 71 functions, for example, as an analysis condition input portion for accepting inputs of analysis conditions from the user. Further, the input interface 71 accepts an instruction to initiate the execution of a pretreatment and various instructions during the pretreatment. Further, the display device 70 displays various alarm information based on the information output from the controller 40. The display device 70 is one example of a notification device.

### <Gripping State>

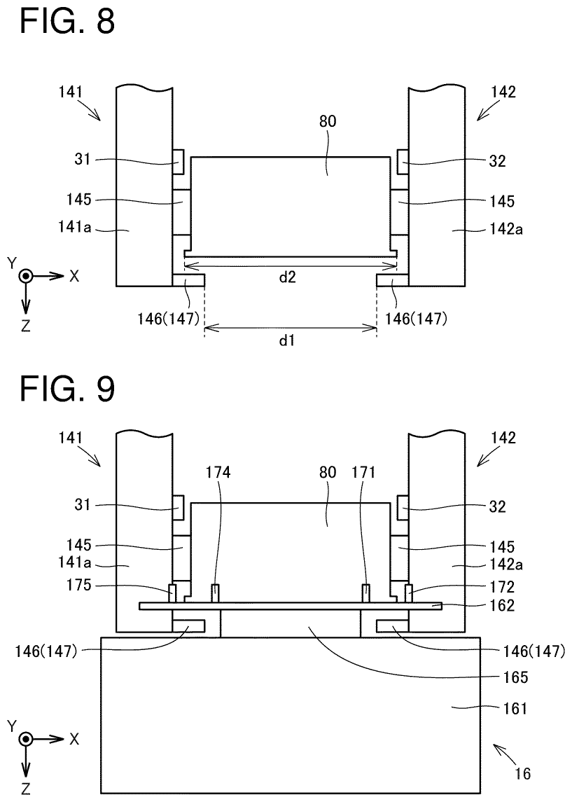

FIG. 8 is a diagram showing a state in which the grippers 141a and 142a are gripping the sample container 80. As shown in FIG. 8, when the grippers 141a and 142a are gripping the sample container 80, the contact portions 145 of the grippers 141a and 142a are brought into contact with the sample container 80. The optical path of the light output from light-projecting unit 31 to the light-receiving unit 32 is blocked by the sample container 80. The controller 40 (see FIG. 4) identifies the presence of the sample container 80 between the gripper 141a and the gripper 142a, based on the non-detection of the light by the light-receiving unit 32.

When the grippers 141a and 142a are gripping the sample container 80, the distance d1 between the protrusion 146, 147 of the gripper 141a and the protrusion 146, 147 of the gripper 142a in the X-axis direction is shorter than the length d2 of the sample container 80 in the X-axis direction. Because of this, when the sample container 80 is being conveyed, if the sample container 80 is displaced from the pair of contact portions 145 and 145, the protrusions 146 and 147 can hold the sample container 80 between the gripper 141a and the gripper 142a.

### <Conveyance to Placement Surface>

FIG. 9 is a diagram showing the state in which the sample container 80 gripped by the grippers 141a and 142a is placed on the module board 162 from above the module board 162. In this stage, the grippers 141a and 142a are gripping the sample container 80 with the contact portions 145. At this time, a part of the gripper 141a, 142a enters the cut-out portion 163 (see FIG. 3) formed in the module board 162. Further, the protrusion 146, 147 of the gripper 141a, 142a is inserted into the space between the module body 161 and the module board 162.

<Movement on Placement Surface (X-axis direction)>

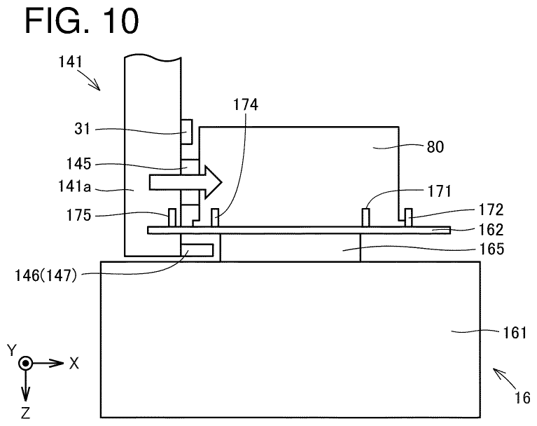

FIG. 10 is a diagram showing the state in which the sample container 80 is moved by the gripper 141a in the positive direction of the X-axis. When moving the sample container 80 in the positive direction of the X-axis, the gripper arm 14 moves the gripper 142a away from the sample container 80. This allows the gripper arm 14 to move the sample container 80 in the positive direction of the X-axis by the gripper 141a. The gripper arm 14 moves the sample container 80 in the positive direction of the X-axis with the contact portion 145 of the gripper 141a in contact with the sample container 80. With this, as shown in FIG. 10, the sample container 80 comes into contact with the positioning pins 172 and 173 to complete the positioning in the X-axis direction.

<Movement on Placement Surface (Y-axis direction)>

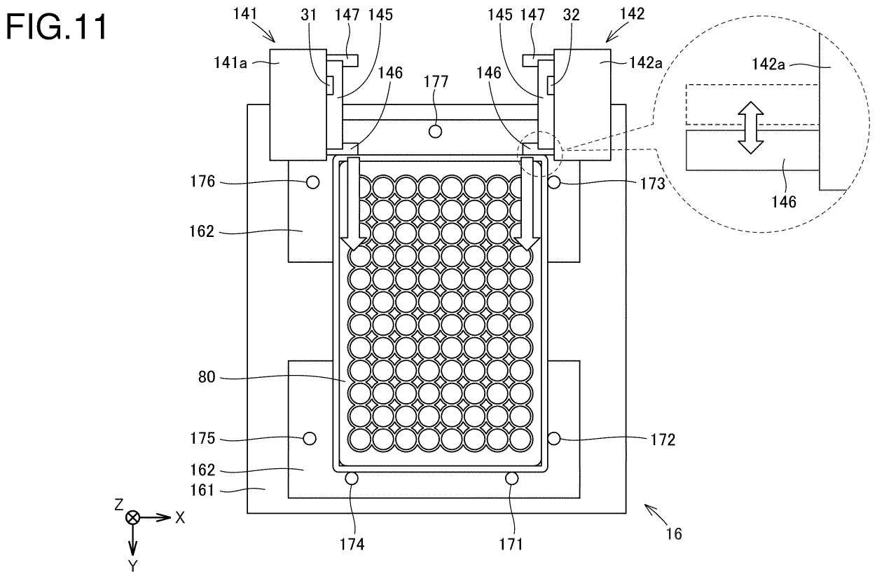

FIG. 11 is a diagram showing the state in which the sample container 80 is moved by the gripper 141a in the positive direction of the Y-axis. At the stage of moving the sample container 80 in the positive direction of the Y-axis on the placement surface, the positioning in the X-axis direction has been completed. For this reason, at the stage of moving the sample container 80 in the positive direction of the Y-axis on the placement surface, the sample container 80 is in contact with the pins 172 and 173. When moving the sample container 80 in the positive direction of the Y-axis, the gripper arm 14 places the grippers 141a and 142a at the position in the negative direction of the Y-axis with respect to the sample container 80.

The gripper arm 14 moves the grippers 141a and 142a in the positive direction of the Y-axis at the same speed with the protrusions 146 of the grippers 141a and 142a in contact with the sample container 80. This allows the sample container 80 to be pushed stably toward the positioning pins 171 from two locations in the X-axis direction. The sample container 80 moves in the positive direction of the Y-axis while maintaining the state of being in contact with the pins 172 and 173. When the sample container 80 moves in the positive direction of the Y-axis, the leaf spring 149 in the gripper 141a, 142a exerts a biasing force. For this reason, the protrusion 146 retracts in the negative direction of the Y-axis in response to the load when the sample container 80 is moved. Eventually, as shown in FIG. 11, the sample container 80 comes into contact with the positioning pin 171 to complete the positioning in the Y-axis direction. At this time, the sample container 80 is in contact with the pin 174 as well.

### <Procedure for Moving Sample Container to Reference Position>

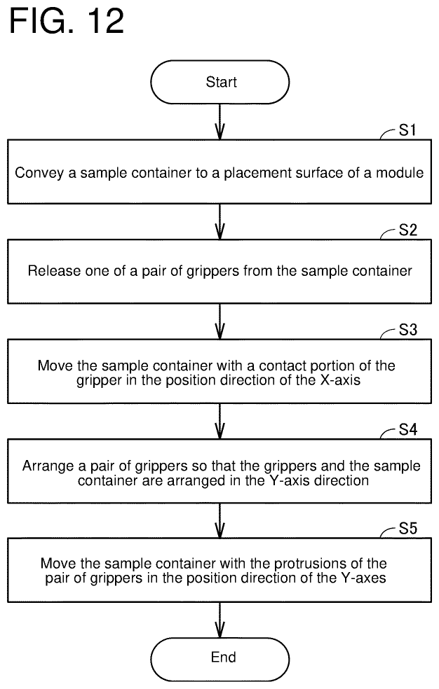

FIG. 12 is a flowchart showing the procedure for moving the sample container 80 to the reference position. Here, the control procedure of the arm mechanism 140 (see FIG. 7), including the gripper arm 14 and the controller 40, will be described based on the flowchart. In the arm mechanism 140, the controller 40 controls the gripper arm 14. The controller 40 controls the operation of the gripper arm 14 by outputting a signal to the conveyance mechanism 13 and the motor circuit 60.

Initially, the arm mechanism 140 conveys the sample container 80 to the placement surface of the module 16 by the conveyance mechanism 13 (Step S1). With this, the sample container 80 is placed on the placement surface as shown in FIG. 9. Next, the arm mechanism 140 releases one of the pairs of grippers 141a and 142a from the sample container (Step S2).

Next, the arm mechanism 140 moves the sample container 80 in the positive direction of the X-axis with the contact portion 145 of the gripper 141a (Step S3). Eventually, the sample container 80 comes into contact with the pins 172 and 173. Then, the motor load equal to or greater than the threshold is detected by the controller 40. The controller 40 stops outputting a drive signal to the motor circuit 60. With this, the arm mechanism 140 stops the operation for moving the sample container 80 in the positive direction of the X-axis. At this time, the positioning of the sample container 80 in the X-axis direction is completed, as shown in FIG. 10.

Next, the arm mechanism 140 arranges a set of grippers 141a and 142a so that the set of grippers 141a and 142a and the sample container 80 are aligned in the Y-axis direction (Step S4). The positional relation between one set of the grippers 141a and 142a and the sample container 80 at this time is shown in FIG. 11.

Next, the arm mechanism 140 moves the sample container 80 in the positive direction of the Y-axis with the contact portion 146 of the gripper 141a (Step S5). Eventually, the sample container 80 comes into contact with the pin 171. At this time, the sample container 80 comes into contact with the pin 174 as well. Then, the motor load equal to or greater than the threshold is detected by the controller 40. The controller 40 stops outputting a drive signal to the motor circuit 60. With this, the arm mechanism 140 stops the operation for moving the sample container 80 in the positive direction of the Y-axis. At this time, as shown in FIG. 11, the positioning of the sample container 80 in the X-axis direction is completed.

Upon completion of the above steps, the sample container 80 is placed at the reference position on the module 16. In this way, the arm mechanism 140 performs positioning in the first direction and the second direction separately. This simplifies the positioning control and enables accurate positioning.

After the sample container 80 is placed at the reference position on the module 16, various preprocessing, such as, e.g., dispensing and tip mounting, is performed. Since the sample container 80 is placed at the reference position of the module 16, a stable pretreatment can be achieved.

Note that when performing a pretreatment, the equipment involved in the pretreatment does not come into direct contact with the sample container 80. Therefore, the sample container 80 does not shift from its reference position during the pretreatment. However, in order to avoid the effects of vibrations caused by earthquakes and other disturbances, the arm mechanism 140 preferably places the sample container 80 at the reference position immediately before the pretreatment.

<Comparison of Positioning Methods (Gripper Arm vs. Spring Mechanism)>

As described above, in this embodiment, the grippers 141a and 142a of the gripper arm 14 are used to move the sample container 80 to the reference position. As for the positioning system, in addition to such “positioning system using the gripper arm 14,” a “positioning system using a spring mechanism” may also be adopted. This section describes the usefulness of the arm system as compared with the positioning system using a spring mechanism. Hereafter, the “positioning system using the gripper arm 14” will be referred to as an “arm system,” and the “positioning system using the spring mechanism” will be referred to as a “spring system.”

Initially, the “spring system” will be described. A positioning vertical wall is provided at one or two of the four corners of the placement surface on the module. A spring mechanism for pressing the sample container against the vertical wall by a biasing force is provided at the position opposing to the vertical wall among the four corners of the placement surface of the module. For example, the spring mechanism may be configured by a roller that comes into contact with the sample container and a spring member that presses the sample container inserted between the roller and the vertical wall against the vertical wall.

The gripper arm lowers the sample container, which has been conveyed above the placement surface, toward the placement surface to be interposed between the vertical wall and the spring mechanism. At this time, the sample container is pressed against the vertical wall by the biasing force of the spring mechanism, and the sample container is fixed at the reference position defined by the vertical wall and the spring mechanism. The above is the description of the spring system.

In the spring system, a force for inserting the sample container between the vertical wall and the spring mechanism against the biasing force of the spring mechanism is required for the gripper arm. The resistance force generated when the sample container is inserted into the space between the vertical wall and the spring mechanism apart and causes the sample container to be inserted between them is significantly greater than the force required for the gripper arm to grip the sample container. If a roller is adopted for the spring mechanism, its resistance force may be reduced slightly by the curved surface of the roller. Even in that case, however, the resistance does not disappear. Therefore, in the spring system, the gripper arm may be overburdened by the force from the direction of the placement surface in the process of inserting the sample container between the positioning vertical wall and the spring mechanism. This may result in a malfunction of the gripper arm.

When the above-described resistance force is greater than the force for the gripper arm to grip the sample container, the sample container may be detached from the gripper arm. In cases where the gripping surface of the sample container is wet with water, or in cases where variations exist in the biasing force of the spring mechanism, the risk of the sample container coming off the gripper arm increases. If the sample container is detached from the gripper arm, the sample container cannot be placed at the reference position. Therefore, a strong gripping force is required for the gripper arm to spread the space between the vertical wall and the spring mechanism with the sample container. However, such gripper arms have a problem that the mechanism becomes more complicated and expensive. Further, if the gripper arm increases the force of gripping the sample container, depending on the strength of the sample container, a part of the sample container may be damaged.

The spring system has various problems as described above. According to the “arm system” of this embodiment, the above-described problems can be eliminated, as will be described below.

In the arm system, the sample container 80 is moved to the reference position by the grippers 141a and 142a of the gripper arm 14 without using a spring mechanism. Therefore, the arm system does not cause problems such as the sample container 80 being detached from the gripper arm 14 when placed at the reference position. Therefore, in the arm system, the gripper arm 14 is not required to grip the sample container 80 with a gripping force greater than that required to convey the sample container 80. As a result, the arm system allows the actuator (e.g., stepper motor) of the gripper arm 14 to be smaller than that of the spring system. This allows the arm system to reduce the cost of the gripper arm 14, as compared with the spring system.

In the arm system, there is no need to provide a spring mechanism in the module 16. The pretreatment apparatus 1 will be equipped with a number of modules 16. Therefore, according to the arm system, the cost of the pretreatment apparatus 1 can be significantly reduced because there is no need to provide a spring mechanism for each of the numerous modules 16.

In the arm system, the width size of the sample container 80 that can be handled is wider than that of the spring system. In the spring system, the distance between the spring mechanism and the vertical wall is constant, so it is not possible to place a sample container of a smaller size at the reference position, where the biasing force of the spring mechanism cannot be exerted. However, the arm system allows the sample container 80 on the module board 162 to be moved to various positions. Therefore, according to the arm system, a sample container significantly smaller in size than the sample container 80 can be placed at the reference position.

As explained above, by adopting the arm system of this embodiment, it is possible to provide an analysis system 100 capable of placing the sample container 80 at the reference position without applying an excessive burden on the gripper arm 14.

In this embodiment, the module board 162 is one example of a placement member having a placement surface. The module board 162 is constituted by a plate-like member. The pins 171-173 are examples of positioning portions and pin-like protrusions. The pins 172 and 173 are each an example of a first positioning portion for defining the position of the sample container relative to the first direction (X-axis direction) in the in-plane direction of the placement surface. The pin 171 is one example of the second positioning portion for determining the position of the sample container relative to the second direction (Y-axis direction) that intersects with the first direction in the in-plane direction of the placement surface. The pin 174 can also be an example of the second positioning portion.

In this embodiment, the gripper 141a and the gripper 142a are an example of a first gripper and that of a second gripper, respectively. In this case, the gripper 141a may be the first gripper, or the gripper 142a may be the first gripper. In this embodiment, the leaf spring 149 is one example of an elastic member. In this embodiment, the module body 161 is one example of a mounting member having a placement surface for placing a placement member thereon.

### <Modifications>

Next, modifications of this embodiment will be described. In this embodiment, the pins 171-173 and the pins 174-176 are arranged at positions that are line symmetrical with respect to the straight line passing through the pin 177 and parallel to the Y-axis. Therefore, instead of using the pins 171-173 to define the reference position of the sample container 80, the pins 174-176 may be used to define the reference position of the sample container 80. Alternatively, the analysis system 100 may be designed so that the reference position of the sample container 80 can be changed as needed. For example, a mode for setting the reference position of the sample container 80 may be provided in the analysis system 100. The pins 174-176 may be arranged at positions that are not line symmetrical with the pins 171-173.

In this embodiment, the pins 171-173 are exemplified as examples of positioning portions. However, the positioning portion is not limited to this type. For example, the positioning portion may be configured by a marker drawn on the module board 162. In this case, a sensor for sensing the positional relation between the marker and the sample container 80 is provided near the positioning portion. As a sensor, for example, an image sensor may be adopted. The controller 40 may determine that the sample container 80 has moved to the marker position based on the detection signal of the sensor.

As such, the positioning portion may be a pin or a marker. However, to simplify the positioning control, the positioning portion is preferably configured by a member to be placed on the placement surface, such as, e.g., a pin. This is because the controller 40 can perform the positioning control with a simpler control than in a case where the sample container is determined to have reached the marker position by an image sensor or other means. More specifically, the controller 40 can determine that the sample container 80 has reached the positioning position by detecting the force received from the pin when the sample container 80 comes into contact with the pin.

In this embodiment, the gripper arm 14 moves the sample container 80 in the X-axis direction with the gripper 141a. However, the gripper arm 14 may move the sample container 80 in the X-axis direction with the gripper 142a. The gripper arm 14 may move the sample container 80 in the positive direction of the X-axis or the positive direction of the Y-axis in a state in which the sample container 80 is gripped by the grippers 141a and 142a (see FIG. 9). The gripper arm 14 may move the sample container 80 to the reference position with one of the arms 141 and 142. Only one arm not having a gripping function may be used to move the sample container 80 to the reference position. In this case, for example, the arm moves the sample container 80 in the X-axis direction with the plane of the end parallel to the Y-axis in contact with the sample container 80 and then moves the sample container 80 in the Y-axis direction with the surface parallel to the X-axis in contact with the sample container 80.

In this embodiment, the sample container 80 is moved in the Y-axis direction with the grippers 141a and 142a. However, the sample container 80 may be moved in the Y-axis direction with any portion of the grippers 141a and 142a other than the protrusion 146. For example, in FIG. 11, the sample container 80 may be moved in the Y-axis direction with the side of the gripper 141a facing the pin 176 and the side of the gripper 142a facing the pin 173. Alternatively, with one of those sides, the sample container 80 may be moved in the Y-axis direction. In other words, the sample container 80 may be moved in the Y-axis direction with the gripper 141a without the gripper 142a or with the gripper 142a without the gripper 141a. In this case, the gripper used to move the sample container 80 in the Y-axis direction is preferably arranged at around the middle position of the sample container 80 in the X-axis direction.

As described above, in this embodiment, the protrusion 146 has a function of preventing the sample container 80 from falling and a function as a buffer when the sample container 80 is moved to the reference position. However, the gripper 141a, 142a may be provided with a protrusion having a dedicated function as a buffer when the sample container 80 is moved to the reference position.

### [Aspects]

It should be understood by those skilled in the art that the above-described embodiments and modifications thereof are specific examples of the following aspects.

### (Item 1)

The analysis system according to one aspect of the present disclosure is an analysis system equipped with a pretreatment apparatus for executing a pretreatment of a sample contained in a sample container, and is provided with a placement member having a placement surface for placing the sample container thereon and an arm mechanism configured to move the sample container. The placement member has a positioning portion for positioning the sample container on the placement surface, and the arm mechanism is configured to move the sample container placed on the placement surface to the positioning portion to place the sample container at a reference position on the placement surface.

According to the analysis system as recited in the above-described Item 1, it is possible to provide an analysis system capable of placing a sample container at a reference position without applying an excessive burden on an arm mechanism.

### (Item 2)

In the analysis system as recited in the above-described Item 1, the arm mechanism includes a conveyance mechanism for conveying the sample container to the placement surface, and the arm mechanism is configured to convey the sample container to the placement surface by the conveyance mechanism and then place the sample container at the reference position on the placement surface.

According to the analysis system as recited in the above-described Item 2, the arm mechanism can convey the sample container to the placement surface, thus reducing costs as compared with the case in which a conveyance mechanism is provided separately from the arm mechanism.

### (Item 3)

In the analysis system as recited in the above-described Item 1 or 2, the positioning portion is configured by a positioning member provided on the placement surface, the positioning member being configured to come into contact with the sample container when the sample container is positioned at the reference position.

According to the analysis system as recited in the above-described Item 3, it is possible to determine that the sample container has reached the positioning position by detecting the force received from the positioning member when the sample container comes in contact with the positioning member, thus enabling a simple control as compared with the case in which the sample container is determined to have reached the positioning position by an image sensor or the like. Therefore, the positioning control can be performed by a simple control as compared with the case in which the sample container is determined to have reached the positioning position by an image sensor or other means.

### (Item 4)

In the analysis system as recited in the above-described Item 1 or 2, the positioning portion is configured by a pin-shaped projection member.

According to the analysis system as recited in the above-described Item 4, the projection member and the sample container can be positioned by making contact at a point, and thus the sample container can be positioned at the reference position more precisely than when the positioning member is configured by a vertical wall.

### (Item 5)

In the analysis system as recited in any one of Items 1 to 4, the positioning portion includes a first positioning portion for determining a position of the sample container with respect to a first direction in an in-plane direction of the placement surface and a second positioning portion for determining a position of the sample container with respect to a second direction that intersects the first direction in the in-plane direction of the placement surface. The arm mechanism is configured to move the sample container in the first direction so that the sample container comes into contact with the first positioning portion and then moves the sample container in the second direction so that the sample container positioned at the first positioning portion comes into contact with the second positioning portion as well.

According to the analysis system as recited in the above-described Item 5, by performing positioning separately in the first direction and the second direction, the positioning control can be simplified, and the positioning can be performed with high accuracy.

### (Item 6)

In the analysis system as recited in the above-described Item 5, the arm mechanism includes a gripper arm for gripping the sample container, and the arm mechanism is configured to convey the sample container to the placement surface by using the gripper arm and then place the sample container at the reference position on the placement surface. The gripper arm includes a first gripper and a second gripper, the first gripper and the second gripper being configured to grip the sample container by pinching the sample container. The arm mechanism is configured to move the sample container with at least one of the first gripper and the second gripper so that the sample container comes into contact with the first positioning portion and the second positioning portion.

According to the analysis system as recited in the above-described Item 6, at least one of the first gripper and the second gripper having a gripping function of the gripper arm can be effectively utilized for the positioning control.

### (Item 7)

In the analysis system as recited in the above-described Item 6, the first gripper and the second gripper each includes
a contact portion configured to come into contact with the sample container when the sample container is gripped between the first gripper and the second gripper, and
a protrusion that protrudes toward a space formed between the first gripper and the second gripper,
the arm mechanism is configured to
move the sample container in the first direction by moving the first gripper in the first direction in a state in which the sample container is in contact with a contact portion of the first gripper, and
move the sample container in the second direction by moving the first gripper and the second gripper in the second direction in a state in which the sample container is in contact with the protrusion of the first gripper and the protrusion of the second gripper.

According to the analysis system as recited in the above-described Item 7, the contact portion which comes into contact with the sample container when the sample container is clamped and gripped can be effectively utilized for the positioning portion control. Further, the protrusion can effectively move the sample container to the positioning portion.

### (Item 8)

In the analysis system as recited in the above-described Item 7, the protrusion of each of the first gripper and the second gripper constitutes a mechanism for retaining the sample container between the first gripper and the second gripper when the sample container is dropped from the contact portion of the first gripper and the contact portion of the second gripper during conveyance of the sample container.

According to the analysis system as recited in the above-described Item 8, the protrusion having a dropout prevention function can be effectively utilized for the positioning portion control.

### (Item 9)

In the analysis system as recited in the above-described Item 7 or 8, the protrusion of each of the first gripper and the second gripper is connected to an elastic member exerting a biasing force in the second direction.

According to the analysis system as recited in the above-described Item 9, by using the biasing force of the elastic member, the sample container can be moved more precisely to the positioning portion without applying an excessive burden on the gripper arm drive.

### (Item 10)

In the analysis system as recited in the above-described Item 9, the elastic member is configured by a leaf spring.

According to the analysis system as recited in the above-described Item 10, the effect achieved by Item 9 is enhanced by utilizing a leaf spring that exerts a more responsive biasing force.

Although some embodiments of the present invention have been described, the embodiments disclosed here should be considered in all respects illustrative and not restrictive. It should be noted that the scope of the present invention is indicated by claims and is intended to include all modifications within the meaning and scope of the claims and equivalents thereof.

1. An analysis system equipped with a pretreatment apparatus for executing a pretreatment of a sample contained in a sample container, the analysis system comprising:
a placement member having a placement surface for placing the sample container thereon; and
an arm mechanism configured to move the sample container,
wherein the placement member has a positioning portion for positioning the sample container on the placement surface, and
wherein the arm mechanism is configured to move the sample container placed on the placement surface to the positioning portion to place the sample container at a reference position on the placement surface.

2. The analysis system as recited in claim 1,
wherein the arm mechanism includes a conveyance mechanism for conveying the sample container to the placement surface, and
wherein the arm mechanism is configured to convey the sample container to the placement surface by the conveyance mechanism and then place the sample container at the reference position on the placement surface.

3. The analysis system as recited in claim 1,
wherein the positioning portion is configured by a positioning member provided on the placement surface, the positioning member being configured to come into contact with the sample container when the sample container is positioned at the reference position.

4. The analysis system as recited in claim 1,
wherein the positioning portion is configured by a pin-shaped projection member.

5. The analysis system as recited in claim 1,
wherein the positioning portion includes
a first positioning portion for determining a position of the sample container with respect to a first direction in an in-plane direction of the placement surface, and
a second positioning portion for determining a position of the sample container with respect to a second direction that intersects the first direction in the in-plane direction of the placement surface,
wherein the arm mechanism is configured to move the sample container in the first direction so that the sample container comes into contact with the first positioning portion and then move the sample container in the second direction so that the sample container positioned at the first positioning portion comes into contact with the second positioning portion as well.

6. The analysis system as recited in claim 5,
wherein the arm mechanism includes a gripper arm for gripping the sample container,
wherein the arm mechanism is configured to convey the sample container to the placement surface by using the gripper arm and then place the sample container at the reference position on the placement surface,
wherein the gripper arm includes a first gripper and a second gripper, the first gripper and the second gripper being configured to grip the sample container by pinching the sample container, and
wherein the arm mechanism is configured to move the sample container with at least one of the first gripper and the second gripper so that the sample container comes into contact with the first positioning portion and the second positioning portion.

7. The analysis system as recited in claim 6,
wherein the first gripper and the second gripper each includes
a contact portion configured to come into contact with the sample container when the sample container is gripped between the first gripper and the second gripper, and
a protrusion provided to protrude toward a space formed between the first gripper and the second gripper,
wherein the arm mechanism is configured to
move the sample container in the first direction by moving the first gripper in the first direction in a state in which the sample container is in contact with a contact portion of the first gripper, and
move the sample container in the second direction by moving the first gripper and the second gripper in the second direction in a state in which the sample container is in contact with the protrusion of the first gripper and the protrusion of the second gripper.

8. The analysis system as recited in claim 7,
wherein the protrusion of each of the first gripper and the second gripper constitutes a mechanism for retaining the sample container between the first gripper and the second gripper when the sample container is dropped from the contact portion of the first gripper and the contact portion of the second gripper during conveyance of the sample container.

9. The analysis system as recited in claim 7,
wherein the protrusion of each of the first gripper and the second gripper is connected to an elastic member exerting a biasing force in the second direction.

10. The analysis system as recited in claim 9,
wherein the elastic member is configured by a leaf spring.
